(19) United States
(12) Patent Application Publication
(10) Pub. No.: US 2026/0259060 A1
(43) Pub. Date: Sep. 3, 2026

(54) MAP GENERATION SYSTEM, MAP GENERATION METHOD AND NON-TRANSITORY COMPUTER READABLE STORAGE MEDIUM

(71) Applicant: DENSO CORPORATION, Kariya-city (JP)

(72) Inventor: Kentaro ARAI, Kariya-city (JP)

(21) Appl. No.: 19/653,452

(22) Filed: Apr. 21, 2026

Related U.S. Application Data
(63) Continuation of application No. PCT/JP2024/043974, filed on Dec. 12, 2024.

(30) Foreign Application Priority Data
Feb. 9, 2024 (JP) 2024-018963

(51) Int. Cl. G01C 21/00; G01S 17/89

(52) U.S. Cl. CPC G01C 21/3815; G01C 21/3837; G01S 17/89

(57) ABSTRACT

A processor of a map generation system for generating a digital map that maps a road structure executes: acquiring point group data established by three-dimensional scanning of the road structure including a travelling road surface by an infrastructure sensor in a scanning coordinate system; generating, in response to a user input of an attention area, conversion data as point group data converted into a road surface coordinate system in which coordinate axes are defined to be in a normal direction of the travelling road surface in the attention area and in a pair of orthogonal directions orthogonal to the normal direction; and outputting the digital map in which a mask area is defined that the mask area masks the outside of the travelling road surface with respect to the road structure in response to the user input of the mask area relative to the conversion data.

### CROSS REFERENCE TO RELATED APPLICATION

The present application is a continuation application of International Patent Application No. PCT/JP2024/043974 filed on Dec. 12, 2024, which designated the U.S. and claims the benefit of priority from Japanese Patent Application No. 2024-018963 filed on Feb. 9, 2024. The entire disclosures of all of the above applications are incorporated herein by reference.

### TECHNICAL FIELD

The present disclosure relates to a technique for generating a digital map that maps road structures.

### BACKGROUND

A conceivable technique teaches a technique for generating a digital map that maps a road structure by using three-dimensional point data established from an output of an in-vehicle sensor.

### SUMMARY

According to an example, a map generation system generates a digital map that maps a road structure. The map generation system includes a processor. The processor may be configured to cause the map generation system to execute: acquiring point group data constructed by three-dimensional scanning of the road structure including a travelling road surface from an infrastructure sensor in a scanning coordinate system; generating, in response to a user input of an attention area with respect to the point group data in the scanning coordinate system, conversion data as the point group data converted into a road surface coordinate system in which coordinate axes are defined in a normal direction of the travelling road surface included in the attention area in the road structure and in a pair of orthogonal directions perpendicular to the normal direction; and outputting the digital map, in which a mask area that masks an area outside the travelling road surface in the road structure is defined, in response to an user input of the mask area with respect to the conversion data of the road surface coordinate system.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing the overall configuration of a map generation system according to an embodiment;

FIG. 2 is a diagram showing a plan view of a road structure which attracts attention in an embodiment;

FIG. 3 is a diagram showing a perspective view for explaining a road structure that attracts attention in an embodiment;

FIG. 4 is a diagram showing a side view for explaining a road structure that attracts attention in an embodiment;

FIG. 5 is a schematic diagram showing a point group data acquired according to an embodiment;

FIG. 6 is a block diagram illustrating a functional configuration of a map generation system according to an embodiment;

FIG. 7 is a flowchart illustrating a map generation flow according to one embodiment;

FIG. 8 is a flow chart illustrating an interactive processing subroutine according to one embodiment;

FIG. 9 is a flow chart illustrating an automatic processing subroutine according to one embodiment;

FIG. 10 is a schematic diagram illustrating a interactive processing subroutine according to an embodiment;

FIG. 11 is a schematic diagram illustrating a interactive processing subroutine according to an embodiment;

FIG. 12 is a schematic diagram illustrating a interactive processing subroutine according to an embodiment;

FIG. 13 is a schematic diagram illustrating a interactive processing subroutine according to an embodiment;

FIG. 14 is a schematic diagram illustrating a interactive processing subroutine according to an embodiment; and

FIG. 15 is a schematic diagram illustrating an automatic processing subroutine according to an embodiment.

### DETAILED DESCRIPTION

In the technique in the conceivable technique, it is necessary to automatically recognize and delete a ground point that represents the road surface on which the vehicle is traveling. However, in three-dimensional point group data that is prepared by using the output from the in-vehicle sensor that moves with the vehicle, it is difficult to accurately distinguish a point group that represents a road structure outside the road surface from a ground point through the automatic recognition. This may result in a decrease in the accuracy of the digital map.

An object of the present embodiments is to provide a map generation system that ensures the accuracy of a digital map. Another object of the present embodiments is to provide a map generation method that ensures the accuracy of the digital map. Yet another object of the present embodiments is to provide a map generation program that ensures the accuracy of a digital map.

Hereinafter, a technical solution of the present disclosure for solving the problem will be described.

According to a first example feature, a map generation system has a processor for generating a digital map that maps a road structure. The processor is configured to execute: acquiring point group data established by three-dimensional scanning of a road structure including a travelling road surface by an infrastructure sensor in a scanning coordinate system; generating, in response to a user input of an attention area for the point group data in the scanning coordinate system, conversion data as point group data converted into a road surface coordinate system in which coordinate axes are defined to be in a normal direction of the travelling road surface included in the attention area in the road structure and in a pair of orthogonal directions orthogonal to the normal direction; and outputting the digital map in which a mask area is defined that the mask area masks the outside of the travelling road surface with respect to the road structure in response to the user input of the mask area relative to the conversion data of the road surface coordinate system.

According to a second example feature, a map generation method is executed by a processor to generate a digital map of a road structure. The map generation method includes: acquiring point group data established by three-dimensional scanning of a road structure including a travelling road surface by an infrastructure sensor in a scanning coordinate system; generating, in response to a user input of an attention area for the point group data in the scanning coordinate system, conversion data as point group data converted into a road surface coordinate system in which coordinate axes are defined to be in a normal direction of the travelling road surface included in the attention area in the road structure and in a pair of orthogonal directions orthogonal to the normal direction; and outputting the digital map in which a mask area is defined that the mask area masks the outside of the travelling road surface with respect to the road structure in response to the user input of the mask area relative to the conversion data of the road surface coordinate system.

According to a third example feature, a map generation program is stored in a storage medium and includes instructions to be executed by a processor for generating a digital map that maps a road structure. The map generation program includes the instructions for causing the processor to execute: acquiring point group data established by three-dimensional scanning of a road structure including a travelling road surface by an infrastructure sensor in a scanning coordinate system; generating, in response to a user input of an attention area for the point group data in the scanning coordinate system, conversion data as point group data converted into a road surface coordinate system in which coordinate axes are defined to be in a normal direction of the travelling road surface included in the attention area in the road structure and in a pair of orthogonal directions orthogonal to the normal direction; and outputting the digital map in which a mask area is defined that the mask area masks the outside of the travelling road surface with respect to the road structure in response to the user input of the mask area relative to the conversion data of the road surface coordinate system.

According to the first to third example features, the point group data established by three-dimensional scanning of a road structure including a travelling road surface by an infrastructure sensor is acquired in a scanning coordinate system. Therefore, according to the first to third example features, in response to the user input of an attention area for the point group data in the scanning coordinate system, the conversion data is generated as the point group data converted into the road surface coordinate system. In this case, in the road surface coordinate system, coordinate axes may be set in the normal direction of the travelling road surface included in the attention area of an user input in the road structure, and in a pair of orthogonal directions perpendicular to the normal direction. Therefore, the conversion data for the road surface coordinate system can accurately reflect the coordinate information regarding the travelling road surface.

Furthermore, according to the first to third example features, a digital map in which a mask area that masks an outside of the travelling road surface in the road structure is defined is output in response to a user input of the mask area relative to the conversion data of the road surface coordinate system. This allows the digital map to reflect not only the coordinate information relating to the road surface as described above, but also coordinate information relating to the road structure disposed outside the road surface. As a result of the above, it is possible to ensure the accuracy of the digital map.

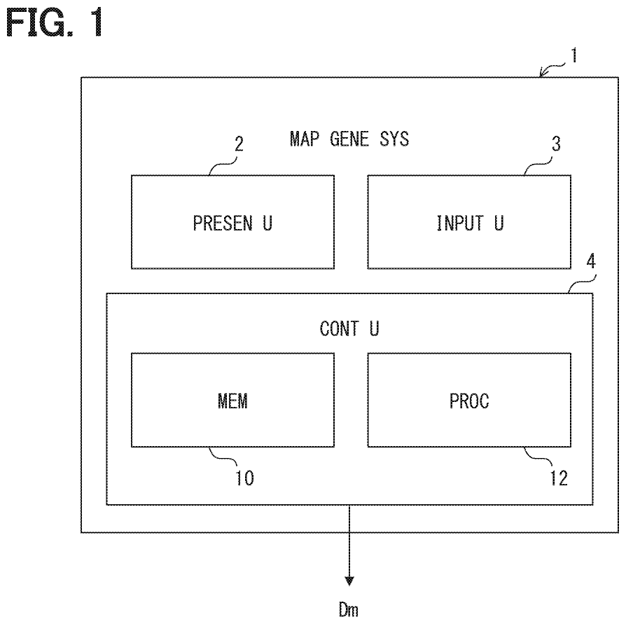

The following will describe an embodiment of the present disclosure with reference to the accompanying drawings. A map generation system 1 according to one embodiment shown in FIG. 1 is installed in an external center such as a data analysis center in order to generate a digital map Dm.

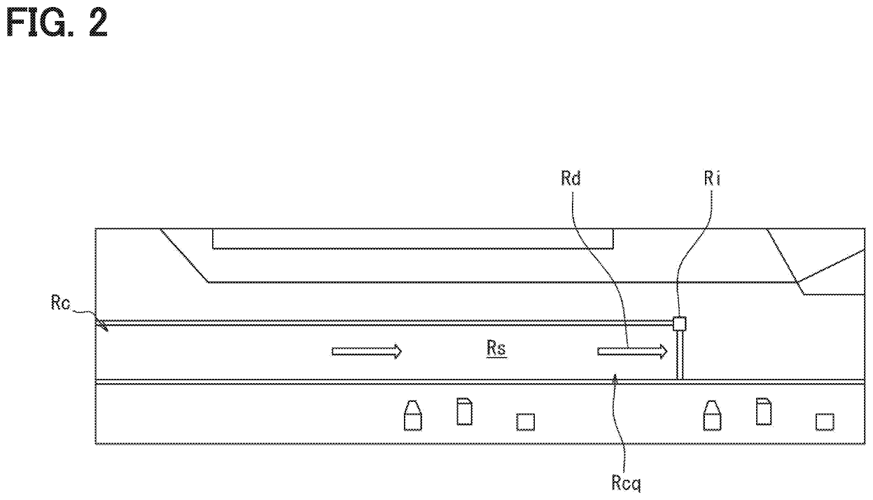

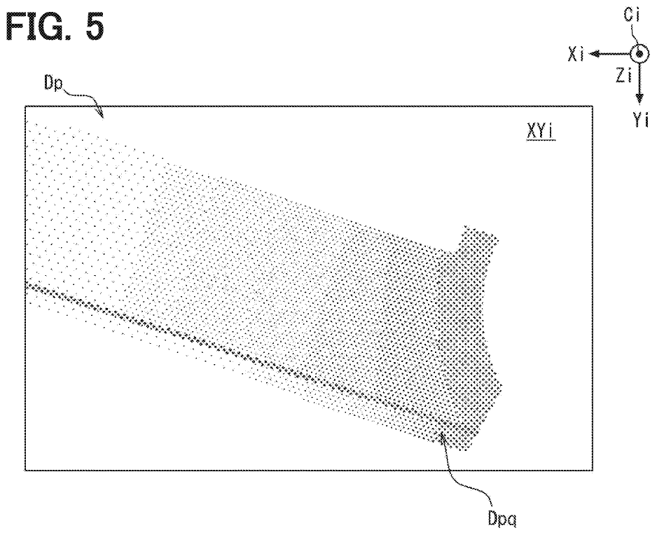

The digital map Dm is digital data in which the road structure Rc as shown in FIGS. 2 to 4 is mapped using the point group information. In particular, the digital map Dm of this embodiment represents a road structure Rc in which the travel direction Rd on the travel road surface Rs is restricted to a specific direction, for example, at an entrance or exit of a road. The digital map Dm is used for, for example, the processing to detect a vehicle traveling in the wrong direction relative to the travelling road direction Rd by map matching the vehicle with respect to the point group data Dp established as shown in FIG. 5 by three-dimensional scanning from an infrastructure sensor Ri installed on the road structure Rc.

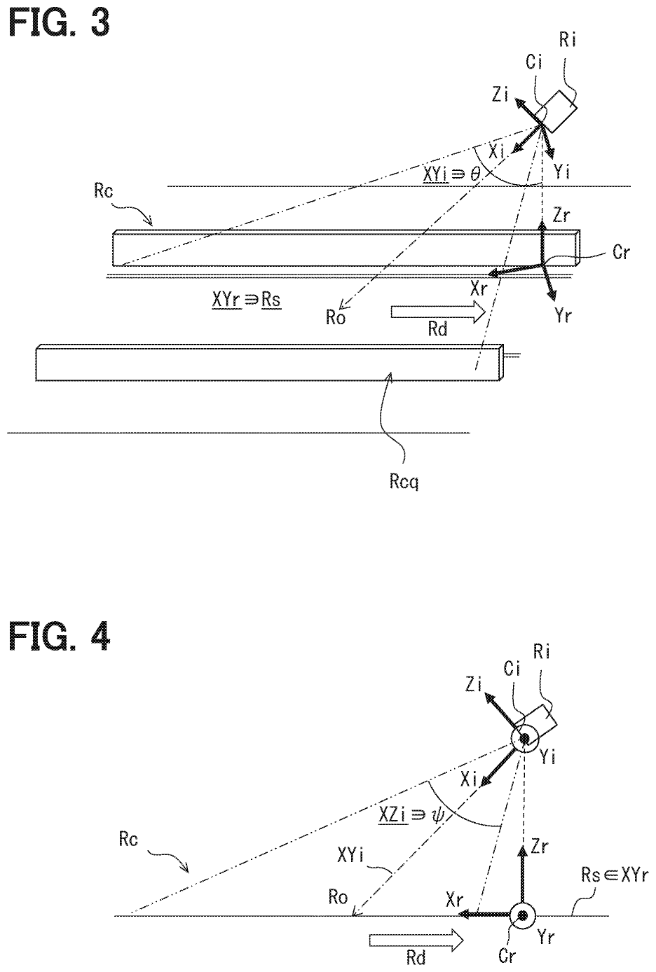

The point group data Dp obtained by the three-dimensional scanning from the infrastructure sensor Ri is also used by the map generation system 1 to generate a digital map Dm. Therefore, the infrastructure sensor Ri employs LiDAR (Light Detection and Ranging/Laser Imaging Detection and Ranging), which is capable of three-dimensionally scanning a scanning target area by irradiating the scanning target area with an infrared light beam within the horizontal view angle θ and the vertical view angle ψ shown in FIGS. 3 and 4.

The infrastructure sensor Ri outputs, for each detection pixel, a signal that correlates with the distance to a target object, including a road structure Rc, within the scanning area. Based on the output signal from the infrastructure sensor Ri, the point group data Dp, in which the three-dimensional position coordinates are individually assigned to each scanning point constituting the scanning point group, can be acquired as shown in FIG. 5.

As shown in FIGS. 3 and 4, the infrastructure sensor Ri is installed in such a position that the optical axis Ro, which is the axis of symmetry for the horizontal view angle θ and the vertical view angle ψ, is inclined at an angle less than a right angle with respect to the road surface Rs. As a result, a scanning coordinate system Ci, which is a three-dimensional Cartesian coordinate system, is defined for the infrastructure sensor Ri. The origin coordinates of the scanning coordinate system Ci are defined as the coordinates of the intersection with the optical axis Ro on the detection surface of the infrastructure sensor Ri. The Xi axis of the scanning coordinate system Ci is defined as a coordinate axis aligned with the optical axis Ro of the infrastructure sensor Ri. The Yi axis of the scanning coordinate system Ci is defined as a coordinate axis orthogonal to the Xi axis on the reference coordinate plane XYi on which the horizontal view angle θ of the infrastructure sensor Ri is defined. The Zi axis of the scanning coordinate system Ci is defined as a coordinate axis orthogonal to the Xi axis and Yi axis on a vertical coordinate plane XZi including the Xi axis, defining the vertical view angle ψ of the infrastructure sensor Ri.

The map generation system 1 shown in FIG. 1 includes a presentation unit 2, an input unit 3, and a control unit 4. The presentation unit 2 presents necessary information to a user who is an operator of the map generation system 1. The presentation unit 2 has at least a liquid crystal panel, an organic EL panel, or the like, for example, that displays image data including the digital map Dm. The presentation unit 2 may be, for example, a speaker that outputs sound related to the display of the digital map Dm. The input unit 3 is at least one of a mouse, a trackball, a keyboard, and the like, which can receive input from a user. The presentation unit 2 and input unit 3 may be configured to be able to jointly provide a GUI (Graphical User Interface) to the processing operator under the control of the control unit 4.

The control unit 4 includes at least one dedicated computer. The control unit 4 is connected to the presentation unit 2 and the input unit 3 via at least one of, for example, a LAN (Local Area Network) line, a wire harness, an internal bus, and a wireless communication line.

The control unit 4 includes at least one memory 10 and one processor 12. The memory 10 is at least one type of non-transitory tangible storage medium of, for example, a semiconductor memory, a magnetic medium, and an optical medium, for non-transitory storing computer readable programs, data, and the like. The processor 12 includes at least one of the CPU, GPU, and RISC-CPU as a core.

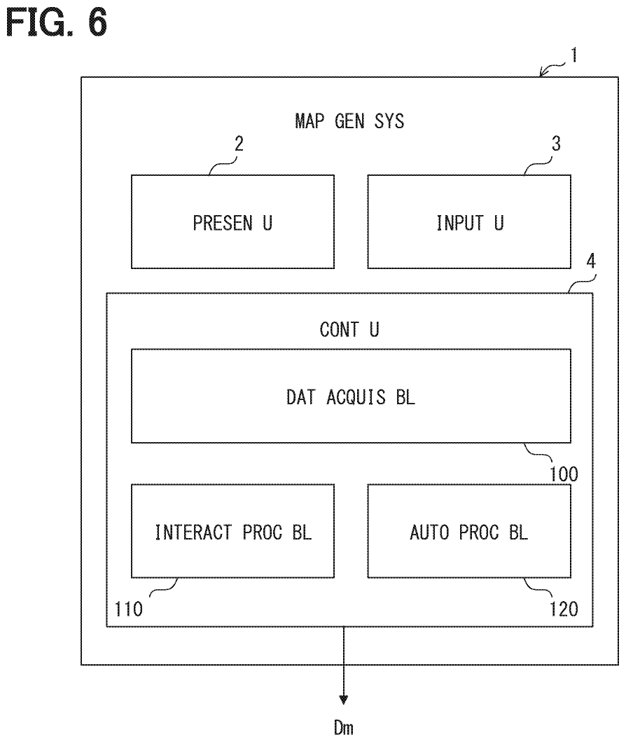

In the control unit 4, a processor 12 executes a number of instructions included in a map generation program stored in a memory 10 to generate a digital map Dm. As a result, the control unit 4 establishes a plurality of functional blocks for generating the digital map Dm. The plurality of functional blocks established in the control unit 4 include a data acquisition block 100, a interactive processing block 110, and an automatic processing block 120, as shown in FIG. 6.

The data acquisition block 100 acquires point group data Dp provided by three-dimensional scanning by an infrastructure sensor Ri. The interactive processing block 110 performs the interactive processing of the generation process of the digital map Dm through a interaction with a user who is an operator of the map generation system 1. The automatic processing block 120 automatically performs the automatic processing of the digital map Dm generation process that is parallel to the interactive processing of the interactive processing block 110, without any interaction with the user. By combining such interactive processing and automatic processing, the digital map Dm is generated as output data from the map generation system 1.

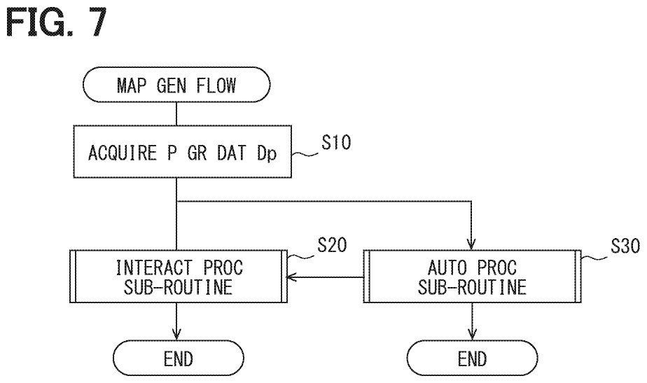

The map generation method in which the map generation system 1 performs the interactive processing and automatic processing to generate the digital map Dm through the cooperation of these blocks 100, 110, and 120 is executed according to the map generation flow shown in FIGS. 7 to 9. This map generation flow is executed in response to a start instruction from a user who is an operator of the map generation system 1. It should be noted that each “S” in this map generation flow represents a step executed by a plurality of instructions included in the map generation program.

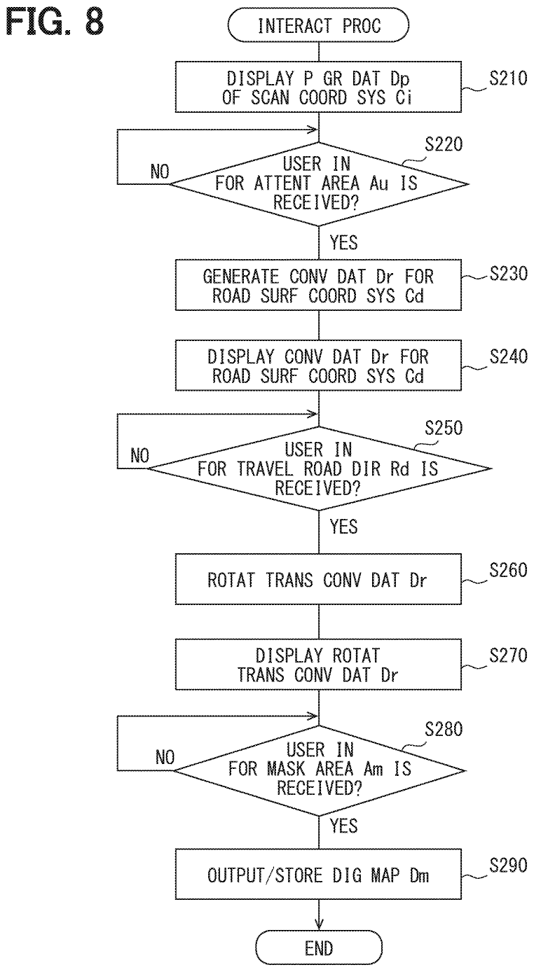

In S10 of the map generation flow, the data acquisition block 100 acquires the point group data Dp constructed by the three-dimensional scanning from the infrastructure sensor Ri of a road structure Rc including a travelling road surface Rs in a scanning coordinate system Ci as shown in FIG. 5. Therefore, as shown in FIG. 7, in steps S20 and S30 following step S10 in the map generation flow, an interactive processing subroutine and an automatic processing subroutine are executed in parallel, respectively. First, the interactive processing subroutine of S20 will be described below with reference to FIG. 8.

In S210 of the interactive processing subroutine, the interactive processing block 110 displays the point group data Dp of the scanning coordinate system Ci acquired in the previous S10 on the presentation unit 2 as shown in FIG. 5. At this time, in the presentation unit 2, under the definition of the scanning coordinate system Ci described above, the point group data Dp is displayed two-dimensionally as two-dimensional image data extending on a reference coordinate plane XYi that is inclined with respect to the road surface Rs.

In S210, the point group data Dp of the scanning coordinate system Ci is displayed in a gradation manner in which the color attribute changes as the position coordinates of the scanning point group is disposed away from the origin coordinates of the infrastructure sensor Ri. The gradation in the display of the point group data Dp may be a hue change state in which the hue of a plurality of display colors as the color attribute of each scanning point gradually changes depending on the distance from the infrastructure sensor Ri. The gradation in the display of the point group data Dp may be a color tone change state in which the color tone determined by the brightness and saturation of a single display color as the color attribute gradually changes depending on the distance from the infrastructure sensor Ri. FIGS. 5 and 10 to 14 show a schematic representation of the gradation manner display described above and below, in which the dot density changes.

As shown in FIG. 8, in S220 following S210 in the dialogue processing subroutine, the interactive processing block 110 accepts a user input via the input unit 3 for the attention area Au with respect to the point group data Dp of the displayed scanning coordinate system Ci. At this time, the input is accepted from the user, who is the operator of the map generation system 1, so that the attention area Au including the road surface Rs on the road structure Rc is surrounded by a contour line shown in FIG. 10 in the displayed point group data Dp. Therefore, in the previous step S210, at least one of the reception display for receiving the user's input for the attention area Au and the instruction display for instructing the user to input for the attention area Au may be performed by the presentation unit 2.

The interactive processing block 110 in S220 determines whether or not a user input for an attention area Au has been received as a interaction between the map generation system 1 and the user who is the operator of the map generation system, as shown in FIG. 8. As long as a negative determination is made as a result, S220 is repeated. On the other hand, if the determination is affirmative, the interactive processing subroutine proceeds to S230.

In S230, which is executed in response to the user input for the attention area Au, the interactive processing block 110 generates the conversion data Dr by converting the point group data Dp from the scanning coordinate system Ci shown in FIGS. 3 to 5 to the road surface coordinate system Cr shown in FIGS. 3, 4, and 11. Specifically, in S230, a gravity center analysis process is performed based on the position coordinates of the scanning point group included within the attention area Au (i.e., within the contour line) that are input by the user for the point group data Dp of the scanning coordinate system Ci before coordinate conversion, so that the gravity center coordinates Pu that constitutes the following expression 1 in the attention area Au is focused on. At the same time, in S230, a main component analysis process is performed based on the position coordinates of the scanning group points included within the attention area Au (i.e., within the contour line), so that the third main component Wu that constitutes the expression 1 in the attention area Au is focused on among the first to third main components. Furthermore, in S230, an approximate plane expressed by the expression 1 using the gravity center coordinates Pu and the third main component Wu is estimated as the travelling road surface Rs that passes through the gravity center coordinates Pu and is perpendicular to the third main component Wu. In the expression 1, xi, yi, and zi represent position coordinates on an approximate plane that represents the road surface Rs in the scanning coordinate system Ci.

$$( {[ xi , yi , zi ]}^{T} - Pu ) \cdot Wu = 0 \qquad ( Expression 1 )$$

Therefore, in S230, a road surface coordinate system Cr, which is a three-dimensional orthogonal coordinate system, is defined for the estimated travelling road surface Rs as shown in FIGS. 3, 4 and 11. At this time, the origin coordinates of the road surface coordinate system Cr are set at the intersection coordinates of a perpendicular line, extending from the origin coordinates of the scanning coordinate system Ci along the vector direction of the third main component Wu to the virtual plane XYr including the travelling road surface Rs, and the travelling road surface Rs.

As a result, in S230, the Zr axis as the coordinate axis of the road surface coordinate system Cr is set on the perpendicular line, extending from the origin coordinate of the scanning coordinate system Ci to the virtual plane XYr along the vector direction of the third main component Wu, which is the normal direction of the travelling road surface Rs. At the same time, in S230, the Xr axis as the coordinate axis of the road surface coordinate system Cr is set perpendicular to the Zr axis on the projection line obtained by orthogonally projecting the Xi axis of the scanning coordinate system Ci onto the virtual plane XYr along the vector direction of the third main component Wu, which is the normal direction of the travelling road surface Rs. Furthermore, in S230, the Yr axis, which is a coordinate axis of the road surface coordinate system Cr, is set on the virtual plane XYr so as to be perpendicular to the Zr axis and the Xr axis. From the above, the Xr axis and the Yr axis are defined to be along a pair of orthogonal directions that are perpendicular to the normal direction of the travelling road surface Rs.

In accordance with this definition of the road surface coordinate system Cr, in S230, a coordinate conversion process is performed to convert the position coordinates of the scanning point group included in the point group data Dp in the scanning coordinate system Ci into the position coordinates of the scanning point group included in the conversion data Dr in the road surface coordinate system Cr. Therefore, in S230, coordinate conversion parameters between the scanning coordinate system Ci and the road surface coordinate system Cr are generated and stored in the memory 10.

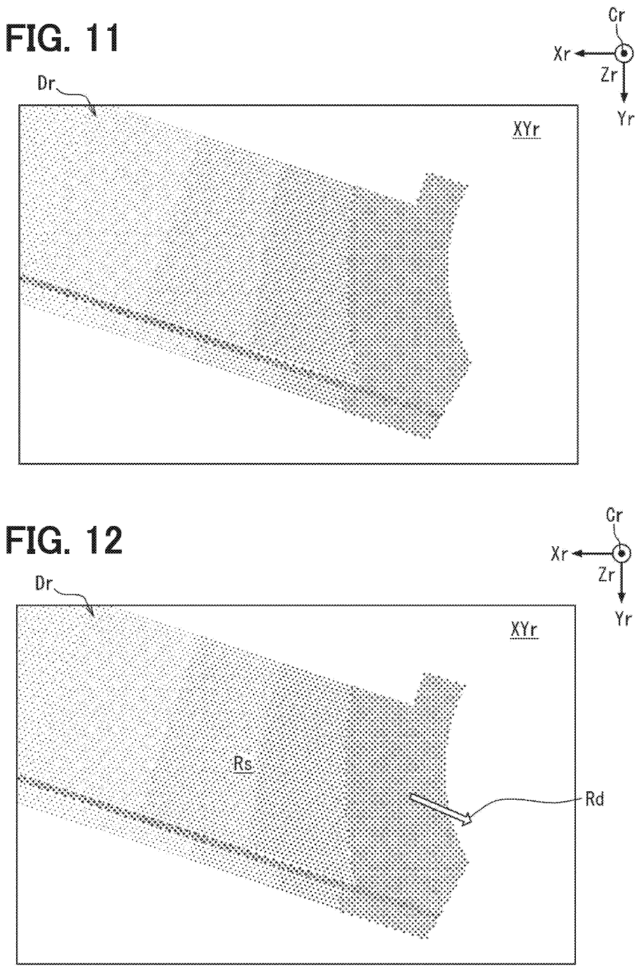

As shown in FIG. 8, in S240 following S230 in the interactive processing subroutine, the interactive processing block 110 displays the conversion data Dr of the road surface coordinate system Cr, which has been converted, on the presentation unit 2 as shown in FIG. 11. At this time, the presentation unit 2 displays the conversion data Dr two-dimensionally as two-dimensional image data that expands on the virtual plane XYr including the travelling road surface Rs under the definition of the road surface coordinate system Cr described above.

In S240, the conversion data Dr of the road surface coordinate system Cr is displayed in a gradation manner in which the color attribute changes as the position coordinates of the scanning point group is disposed away from the origin coordinates of the road surface coordinate system Cr. At this time, since the distance between the origin coordinates of the scanning coordinate system Ci, which is the coordinate of the intersection with the optical axis Ro on the detection surface of the infrastructure sensor Ri, and the origin coordinates of the road surface coordinate system Cr is constant, the display of the conversion data Dr can also be in the form of a gradation in which the color attributes change as the position coordinates of the scanning point group is disposed away from the infrastructure sensor Ri. The gradation in the display of the conversion data Dr may be either a hue change state or a color tone change state, similar to the display of the point group data Dp in S210.

As shown in FIG. 8, in S250 following S240 in the interactive processing subroutine, the interactive processing block 110 accepts a user input via the input unit 3 of the travelling road direction Rd relative to the conversion data Dr of the displayed road surface coordinate system Cr. At this time, an input is accepted from the user, who is the operator of the map generation system 1, so that the travelling road direction Rd assumed on the road surface Rs is indicated by an arrow shown in FIG. 12 in the conversion data Dr to be displayed. Therefore, in the previous S240, at least one of the reception display for receiving the user input of the travelling road direction Rd and the instruction display for instructing the user to input the travelling road direction Rd may be performed from the presentation unit 2.

The interactive processing block 110 in S250 determines whether or not a user input of the travelling road direction Rd has been received as an interaction between the map generation system 1 and the user who is operator of the map generation system 1, as shown in FIG. 8. As a result, S250 is repeated as long as a negative determination is made. On the other hand, if the determination is affirmative, the interactive processing subroutine proceeds to S260.

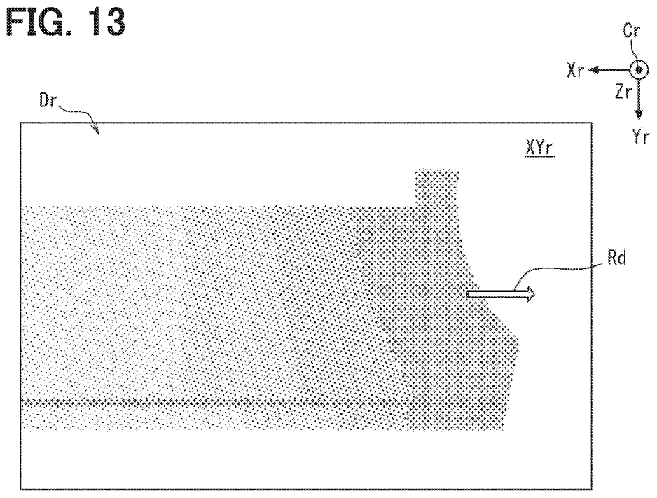

In S260, which is executed in response to the user's input of the travelling road direction Rd, the interactive processing block 110 further performs rotation transformation on the conversion data Dr to match the travelling road direction Rd, as shown in FIG. 13. This rotation transformation process matches (i.e., coincides) the travelling road direction Rd of the road surface Rs included in the attention area Au in the road structure Rc along the Xr axis direction in this embodiment, which is one of the directions perpendicular to the normal direction of the road surface Rs in the road surface coordinate system Cr. Therefore, in S260, the coordinate conversion parameters between the scanning coordinate system Ci and the road surface coordinate system Cr stored in S230 are combined with the rotation transformation parameters of the road surface coordinate system Cr, and the combined result is stored in the memory 10. The combined data of the coordinate conversion parameters and the rotation transformation parameters stored in this manner will be referred to as a combined conversion parameters between the scanning coordinate system Ci and the road surface coordinate system Cr hereinafter.

As shown in FIG. 8, in S270 following S260 in the interactive processing subroutine, the interactive processing block 110 displays the rotationally transformed conversion data Dr of the road surface coordinate system Cr on the presentation unit 2 as shown in FIG. 13. At this time, in the presentation unit 2, the conversion data Dr as the two-dimensional image data in which the travelling road direction Rd overlaps with the Xr axis direction on the virtual plane XYr including the road surface Rs is displayed two-dimensionally in a gradation manner similar to S240.

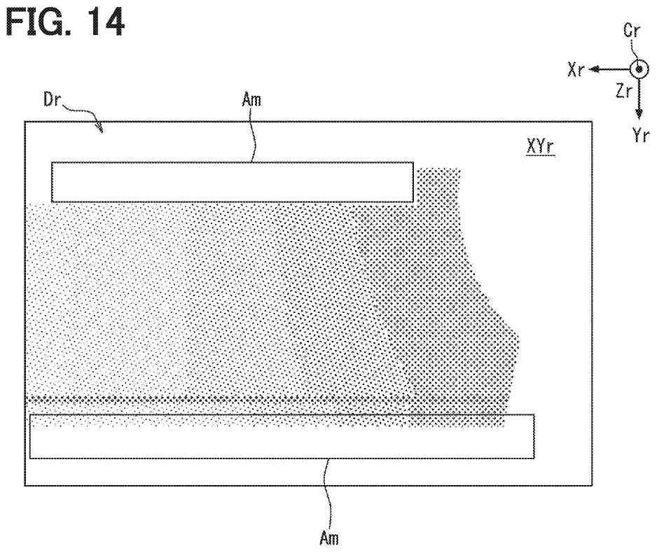

As shown in FIG. 8, in S280 following S270 in the interactive processing subroutine, the interactive processing block 110 accepts the user input via the input unit 3 for the mask area Am with respect to the conversion data Dr after the rotation transformation of the displayed road surface coordinate system Cr. At this time, the input is accepted from the user, who is the operator of the map generation system 1, so that the mask area Am, which masks the area outside the travelling road surface Rs in the road structure Rc, is surrounded by a contour line shown in FIG. 14 in the display conversion data Dr. Therefore, in the previous step S270, at least one of the reception display for receiving the user input for the mask area Am and the instruction display for instructing the user to input for the mask area Am may be performed by the presentation unit 2.

The interactive processing block 110 in S280 determines whether or not a user input for a mask area Am has been accepted as an interaction between the map generation system 1 and the user who is the operator of the map generation system 1, as shown in FIG. 8. As long as the result is negative, S280 is repeated. On the other hand, if the determination is affirmative, the interactive processing subroutine proceeds to S290.

Thus, in response to the user input of a mask area Am, the interactive processing block 110 outputs a defined digital map Dm of the mask area Am at S290. At this time, the digital map Dm is output as the point group data Dp of the scanning coordinate system Ci, to which the coordinate information of the mask area Am in the road surface coordinate system Cr is added, along with the combined conversion parameters between the scanning coordinate system Ci and the road surface coordinate system Cr. In this embodiment in particular, it may be preferable that the coordinate information of the mask area Am includes position coordinates of each scanning point on and/or within the contour line. In this way, in S290, the output digital map Dm is stored in the memory 10, and the interactive processing subroutine is completed.

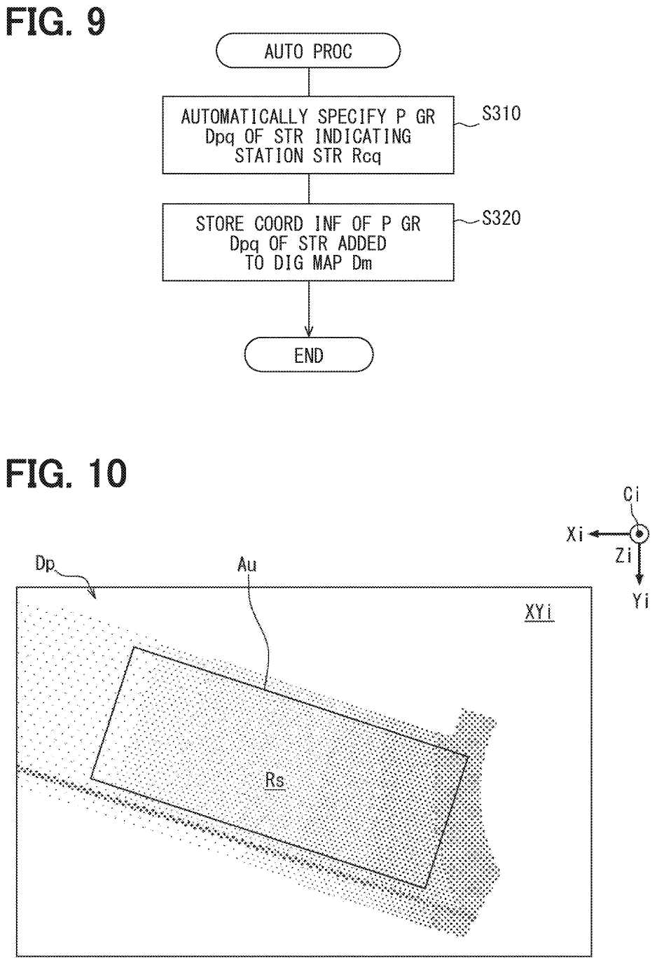

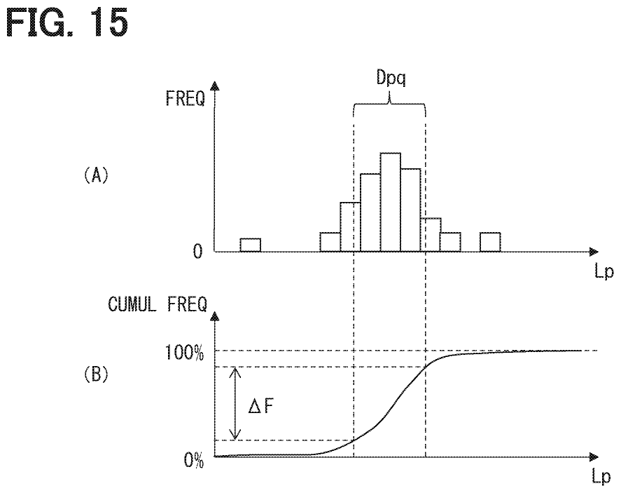

Next, the automatic processing subroutine of S30 shown in FIG. 7 will be described with reference to FIG. 9. In S310 of the automatic processing subroutine, the automatic processing block 120 automatically specifies the structure point group Dpq shown in FIG. 5 as the scanning point group representing the stationary structure Rcq shown in FIGS. 2 and 3 of the road structure Rc in the point group data Dp of the scanning coordinate system Ci acquired in the previous S10. At this time, the structure point group Dpq is specified in the point group data Dp of the scanning coordinate system Ci by frequency analysis of the scanning point group regarding the separation distance Lp from the infrastructure sensor Ri as shown in FIG. 15. Therefore, in this embodiment in particular, using the point group data Dp acquired over multiple frames at S10, the scanning point group is specified as the structure point group Dpq, in which the cumulative frequency of each detection pixel regarding the separation distance Lp from the infrastructure sensor Ri falls within the intermediate frequency ΔF, which is set to a range exceeding 0% and less than 100% of the total frequency as shown in (B) of FIG. 15.

As shown in FIG. 9, in S320 of the automatic processing subroutine, the automatic processing block 120 stores in the memory 10 the coordinate information, which is the position coordinates of each scanning point that constitutes the specified structure point group Dpq, as information to be added to the digital map Dm that is output in S290 of the above-mentioned interactive processing subroutine. Once this storage in S320 is performed, the automatic processing subroutine is completed. Therefore, the coordinate information of the stored structure point group Dpq is added to the digital map Dm together with the combined conversion parameters between the coordinate systems Ci and Cr and the coordinate information of the mask area Am in S290 of the interactive processing subroutine. Therefore, upon completion of S290 by performing the above-mentioned addition processing, the map generation flow ends.

### Functions and Effects

The operation and effects in the present embodiment described above will be explained below.

In this embodiment, the point group data Dp constructed by the three-dimensional scanning of a road structure Rc including a travelling road surface Rs from the infrastructure sensor Ri is acquired in a scanning coordinate system Ci. Therefore, according to this embodiment, in response to a user input of an attention area Au for the point group data Dp in the scanning coordinate system Ci, the conversion data Dr is generated as the point group data Dp converted into the road surface coordinate system Cr. In this case, the road surface coordinate system Cr is assumed to have coordinate axes Xr, Yr, and Zr in the normal direction of the road surface Rs included in the user-input attention area Au in the road structure Rc and in a pair of orthogonal directions perpendicular to the normal direction. Therefore, the conversion data Dr into the road surface coordinate system Cr can accurately reflect the coordinate information regarding the travelling road surface Rs.

Moreover, according to this embodiment, a digital map Dm that defines a mask area Am that masks the area outside the travelling road surface Rs in the road structure Rc is output in response to a user input of the mask area Am for the conversion data Dr of the road surface coordinate system Cr. As a result, not only the coordinate information relating to the travelling road surface Rs as described above, but also the coordinate information relating to the road structure Rc outside the travelling road surface Rs can be reflected in the digital map Dm. As a result of the above, it is possible to ensure the accuracy of the digital map Dm.

According to this embodiment, the user input of the attention area Au is accurate for the point group data Dp of the displayed scanning coordinate system Ci, and the accuracy of the coordinate information reflected in the travelling road surface Rs can be guaranteed in the conversion data Dr generated in response to the user input. Furthermore, since the user input into the mask area Am is also accurate for the conversion data Dr of the displayed road surface coordinate system Cr, the accuracy of the coordinate information in the digital map Dm output in response to the user input, reflected not only for the travelling road surface Rs but also for the road structure Rc outside the travelling road surface Rs, can be guaranteed. Therefore, it is possible to generate the digital map Dm with high accuracy.

In this embodiment, the point group data Dp of the scanning coordinate system Ci constructed by the three-dimensional scanning from the infrastructure sensor Ri, which is assumed to have a horizontal angle of view θ on a reference coordinate plane XYi that is inclined relative to the road surface Rs, is displayed in a gradational manner. In this gradation display, the color attributes change as the position coordinates of the scanning point group in the point group data Dp are disposed away from the infrastructure sensor Ri, so that the accurate user input of the attention area Au is promoted, and the gradation display contributes to the highly accurate generation of the digital map Dm.

According to this embodiment, the conversion data Dr of the road surface coordinate system Cr is displayed in a gradation manner. Even with this gradation display, the color attributes change as the position coordinates of the scanning point group in the conversion data Dr are disposed away from the infrastructure sensor Ri, so that the accurate user input of the mask area Am is also promoted, and thereby the gradation display contributes to the highly accurate generation of the digital map Dm.

According to this embodiment, the conversion data Dr is rotationally transformed in response to a user input of the travelling road direction Rd so that the travelling road direction Rd of the road surface Rs included in the attention area Au in the road structure Rc matches along one of the orthogonal directions to the normal direction of the road surface Rs in the road surface coordinate system Cr. This can promote the accurate user input of the mask area Am for the conversion data Dr of the road surface coordinate system Cr that will be displayed in a rotationally transformation state, thereby contributing to the highly accurate generation of the digital map Dm.

According to this embodiment, the point group data Dp of the scanning coordinate system Ci, to which the coordinate information of the mask area Am in the road surface coordinate system Cr is added along with the combined conversion parameters between the scanning coordinate system Ci and the road surface coordinate system Cr, is output as a digital map Dm. According to this feature, the digital map Dm after generation can be utilized, for example, in map matching with the point group data Dp from the infrastructure sensor Ri mentioned above, so that it is possible to accurately detect a mobile object limited to the road surface Rs while omitting additional coordinate conversion processing.

In this embodiment, a structure point group Dpq representing a stationary structure Rcq of the road structure Rc is specified by frequency analysis of the scanning point group regarding the separation distance Lp from the infrastructure sensor Ri in the point group data Dp of the scanning coordinate system Ci. According to this feature, the point group data Dp of the scanning coordinate system Ci to which the coordinate information of the structure point group Dpq has been added is output as a digital map Dm, so that it is possible to generate a digital map Dm with high accuracy that also accurately reflects the structure point group Dpq. In particular, according to this embodiment, the scanning point group in the point group data Dp of the scanning coordinate system Ci, whose cumulative frequency for the separation distance Lp is within the intermediate frequency ΔF, can be accurately specified as the structure point group Dpq with high certainty, thereby contributing to the highly accurate generation of the digital map Dm.

### Other Embodiments

Although one embodiment has been described, the present disclosure should not be limited to the above embodiment and may be applied to various other embodiments within the scope of the present disclosure.

As a modification, the dedicated computer that constitutes the map generation system 1 may have at least one of a digital circuit and an analog circuit as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such digital circuits may also include a memory for storing program.

As a modification example, in at least one of steps S210, S240, and S270, instead of a gradation display in which the color attribute changes, a monochromatic display in which the color attribute of each scanning point is set constant may be performed. As a modification example, S250, S260, and S270 may be omitted, and the user input of the mask area Am in S280 may be received with respect to the conversion data Dr of the road surface coordinate system Cr that has been coordinate-converted in S230 and displayed in S240.

As a modification example, S30 (or S310 and S320) may be omitted, and the coordinate information of the structure point group Dpq may be omitted from the additional information added to the digital map Dm in S290. As a modification example, in S290, the combined conversion parameters between the coordinate systems Ci and Cr may be omitted from the additional information to the digital map Dm, and the conversion data Dr of the road surface coordinate system Cr to which the coordinate information of the mask area Am has been added may be output as the digital map Dm.

In addition to the features described so far, the above-described embodiments and variations may be implemented in the form of a processing device (e.g., a processing ECU, and the like) or a semiconductor device (e.g., a semiconductor chip, and the like) as a map generation system having at least one processor 12 and one memory 10.

The present specification discloses a plurality of technical ideas listed below and a plurality of combinations thereof. Note that the symbols in parentheses in the following features indicate the correspondence with the specific means described in the previously detailed embodiments, and do not limit the technical scope of the present disclosure.

### Technical Feature 1

A map generation system includes a processor (12) for generating a digital map (Dm) that maps a road structure (Rc). The processor is configured to cause the map generation system to execute: acquiring point group data (Dp) constructed by three-dimensional scanning of the road structure including a travelling road surface (Rs) from an infrastructure sensor (Ri) in a scanning coordinate system (Ci); generating, in response to a user input of an attention area (Au) with respect to the point group data in the scanning coordinate system, conversion data (Dr) as the point group data converted into a road surface coordinate system (Cr) in which coordinate axes (Xr, Yr, Zr) are defined in a normal direction of the travelling road surface included in the attention area (Au) in the road structure and in a pair of orthogonal directions perpendicular to the normal direction; and outputting the digital map, in which a mask area (Am) that masks an area outside the travelling road surface in the road structure is defined, in response to an user input of the mask area with respect to the conversion data of the road surface coordinate system.

### Technical Idea 2

In the map generation system according to technical feature 1, the generating of the conversion data includes generating the conversion data in response to the user input of the attention area with respect to the point group data in the scanning coordinate system to be displayed. The outputting of the digital map includes outputting the digital map in response to the user input of the mask area with respect to the conversion data of the road surface coordinate system to be displayed.

### Technical Feature 3

In the map generation system according to technical feature 2, the generating of the conversion data includes displaying the point group data in the scanning coordinate system constructed by the three-dimensional scanning of the infrastructure sensor, in which a horizontal angle of view (θ) is defined on a reference coordinate plane (XYi) that is inclined from the travelling road surface, in a gradation form in which a color attribute changes as position coordinates of a scanning point group is disposed away from the infrastructure sensor.

### Technical Feature 4

In the map generation system according to technical feature 2 or 3, the outputting of the digital map includes displaying the conversion data in the road surface coordinate system in a gradation form in which a color attribute changes as position coordinates of a scanning point group is disposed away from the infrastructure sensor.

### Technical Feature 5

In the map generation system according to technical feature 2, the generating of the conversion data includes rotationally transforming the conversion data in response to an user input of a travelling road direction (Rd) of the travelling road surface included in the attention area in the road structure in order to match the road direction along one of the orthogonal directions in the road surface coordinate system.

### Technical Feature 6

In the map generation system according to technical feature 2 or 3, the outputting of the digital map includes outputting the point group data in the scanning coordinate system as the digital map, to which coordinate information of the mask area in the road surface coordinate system has been added along with a conversion parameter between the scanning coordinate system and the road surface coordinate system.

### Technical Feature 7

In the map generation system according to technical feature 6, the processor is configured to cause the map generation system to further execute: specifying a structure point group (Dpq) representing a stationary structure (Rcq) of the road structure by frequency analysis of a scanning point group with respect to a separation distance (Lp) from the infrastructure sensor in the point group data in the scanning coordinate system. In the map generation system, the outputting of the digital map includes outputting the point group data in the scanning coordinate system, to which coordinate information of the structure point group has been added, as the digital map.

### Technical Feature 8

In the map generation system according to technical feature 7, the specifying of the structure point group includes: specifying a scanning point group, whose cumulative frequency with respect to the separation distance in the point group data in the scanning coordinate system is within a intermediate frequency (ΔF), as the structure point group.

The above-mentioned technical features 1 to 8 may be understood as the respective technical features of a method and a program.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A map generation system for generating a digital map that maps a road structure, the map generation system comprising:
a processor, wherein:
the processor is configured to cause the map generation system to execute:
acquiring point group data constructed by three-dimensional scanning of the road structure including a travelling road surface from an infrastructure sensor in a scanning coordinate system;
generating, in response to a user input of an attention area with respect to the point group data in the scanning coordinate system, conversion data as the point group data converted into a road surface coordinate system in which coordinate axes are defined in a normal direction of the travelling road surface included in the attention area in the road structure and in a pair of orthogonal directions perpendicular to the normal direction; and
outputting the digital map, in which a mask area that masks an area outside the travelling road surface in the road structure is defined, in response to an user input of the mask area with respect to the conversion data of the road surface coordinate system.

2. The map generation system according to claim 1, wherein:
the generating of the conversion data includes generating the conversion data in response to the user input of the attention area with respect to the point group data in the scanning coordinate system to be displayed; and
the outputting of the digital map includes outputting the digital map in response to the user input of the mask area with respect to the conversion data of the road surface coordinate system to be displayed.

3. The map generation system according to claim 2, wherein:
the generating of the conversion data includes displaying the point group data in the scanning coordinate system constructed by the three-dimensional scanning of the infrastructure sensor, in which a horizontal angle of view is defined on a reference coordinate plane that is inclined from the travelling road surface, in a gradation form in which a color attribute changes as position coordinates of a scanning point group is disposed away from the infrastructure sensor.

4. The map generation system according to claim 2, wherein:
the outputting of the digital map includes displaying the conversion data in the road surface coordinate system in a gradation form in which a color attribute changes as position coordinates of a scanning point group is disposed away from the infrastructure sensor.

5. The map generation system according to claim 2, wherein:
the generating of the conversion data includes rotationally transforming the conversion data in response to an user input of a travelling road direction (Rd) of the travelling road surface included in the attention area in the road structure in order to match the road direction along one of the orthogonal directions in the road surface coordinate system.

6. The map generation system according to claim 1, wherein:
the outputting of the digital map includes outputting the point group data in the scanning coordinate system as the digital map, to which coordinate information of the mask area in the road surface coordinate system has been added along with a conversion parameter between the scanning coordinate system and the road surface coordinate system.

7. The map generation system according to claim 6, wherein:
the processor is configured to cause the map generation system to further execute:
specifying a structure point group representing a stationary structure of the road structure by frequency analysis of a scanning point group with respect to a separation distance from the infrastructure sensor in the point group data in the scanning coordinate system; and
the outputting of the digital map includes outputting the point group data in the scanning coordinate system, to which coordinate information of the structure point group has been added, as the digital map.

8. The map generation system according to claim 7, wherein:
the specifying of the structure point group includes: specifying a scanning point group, whose cumulative frequency with respect to the separation distance in the point group data in the scanning coordinate system is within a intermediate frequency, as the structure point group.

9. A map generation method executed by a processor to generate a digital map of a road structure, the map generation method comprising:
acquiring point group data constructed by three-dimensional scanning of the road structure including a travelling road surface from an infrastructure sensor in a scanning coordinate system;
generating, in response to a user input of an attention area with respect to the point group data in the scanning coordinate system, conversion data as the point group data converted into a road surface coordinate system in which coordinate axes are defined in a normal direction of the travelling road surface included in the attention area in the road structure and in a pair of orthogonal directions perpendicular to the normal direction; and
outputting the digital map, in which a mask area that masks an area outside the travelling road surface in the road structure is defined, in response to an user input of the mask area with respect to the conversion data of the road surface coordinate system.

10. A non-transitory computer readable storage medium comprising instructions being executed by a computer, the instructions including a computer-implemented method for generating a digital map that maps a road structure, wherein:
the instructions includes:
acquiring point group data constructed by three-dimensional scanning of the road structure including a travelling road surface from an infrastructure sensor in a scanning coordinate system;
generating, in response to a user input of an attention area with respect to the point group data in the scanning coordinate system, conversion data as the point group data converted into a road surface coordinate system in which coordinate axes are defined in a normal direction of the travelling road surface included in the attention area in the road structure and in a pair of orthogonal directions perpendicular to the normal direction; and
outputting the digital map, in which a mask area that masks an area outside the travelling road surface in the road structure is defined, in response to an user input of the mask area with respect to the conversion data of the road surface coordinate system.
